(19) United States
(12) Patent Application Publication
(10) Pub. No.: US 2019/0236722 A1
(43) Pub. Date: Aug. 1, 2019

(54) SYSTEMS AND METHODS FOR PROVIDING AN ON-LINE DATING SERVICE

(71) Applicant: Anupama Padiadpu Subramanya Bhat, Costa Mesa, CA (US)

(72) Inventor: Anupama Padiadpu Subramanya Bhat, Costa Mesa, CA (US)

(21) Appl. No.: 16/380,934

(22) Filed: Apr. 10, 2019

Related U.S. Application Data
(63) Continuation-in-part of application No. 16/262,008, filed on Jan. 30, 2019.
(60) Provisional application No. 62/655,228, filed on Apr. 10, 2018.
(60) Provisional application No. 62/624,819, filed on Feb. 1, 2018.

(51) Int. Cl. G06Q 50/00; H04L 29/08; G06F 16/9535; G06F 16/9032; G06F 16/957; G06Q 30/06; G06Q 10/02; G06Q 20/04

(52) U.S. Cl. CPC G06Q 50/01; H04L 67/306; G06F 16/9535; G06Q 20/0453; G06F 16/9574; G06Q 30/0641; G06Q 10/02; G06F 16/90328

(57) ABSTRACT

Systems and methods for providing an on-line dating application that reduces dating fatigue and reduces the chances being catfished by potential dates.

### CROSS-REFERENCE TO RELATED APPLICATIONS

This application claims priority to U.S. Provisional Patent Application Ser. No. 62/655,228, filed on Apr. 10, 2018, and is a continuation-in-part application of U.S. patent application Ser. No. 16/262,008, filed on Jan. 30, 2019, which claims priority to U.S. Provisional Patent Application Ser. No. 62/624,819, filed on Feb. 1, 2018, the entire content of each of these applications is expressly incorporated herein by reference.

### STATEMENT RE: FEDERALLY SPONSORED RESEARCH/DEVELOPMENT

Not Applicable.

### BACKGROUND

A dating or matchmaker service typically provides a dating application (commonly called a dating App) that attempts to identify and bring together two or more people that the service believes may have a successful relationship. Many dating applications identify matches by various techniques. However, these matching techniques are often not successful in determining whether a relationship will be successful. As such, predicting relationship success has been unreliable.

After identifying candidates for a match, many dating services allow the candidates to communicate by chat, telephone or by e-mail. However, doing so has provided its challenges. Accordingly, there is a need in dating applications for improving communication between matched candidates

There have been many prior art improvements in dating applications. For example, U.S. Pat. No. 7,246,067 issued to Austin on Jul. 17, 2007 describes a method for verifying information submitted by users to an online dating system. Also, U.S. Pat. No. 7,203,674 issued to Cohen on Apr. 10, 2007 describes a method and system for integrating real-time speed dating with an electronic dating service. Still further, U.S. Pat. Application No. 20060059130 published to Weiss on Mar. 16, 2006 describes a system and method for improving an online dating service's search results based on a user's compatibility feedback. However, all of the above describe systems suffer from shortcomings.

Accordingly, there is a need for an improved dating application.

### SUMMARY

The above and other problems are addressed and an advance in the art is made by a data application provided in accordance with the various aspects described herein.

In a first aspect of the disclosed system, a dating application server system may provide private profile information to two or more users only after mutual agreement by the two or more users to share each other's private profile information. To do so, the dating application server system receives a like of public content of a profile of a first user from a second user. The system may then receive an acceptance of the like from the first user. In response to receiving the like and the acceptance, the dating application server system may provide access to private content in the profile of the first user to the second user and provides access to private content in a profile of the second user to the first user. Optionally, it is also contemplated that the system may provide private content of the first user to the second user after the system receives the like and acceptance and also after first user chooses to share the private content of the first user, and vice versa. The first user may choose to share the private content of the first user by selecting a share private content button displayed by the system on a screen.

In some embodiments, the dating application server system may provide private content from the profile of the second user to the first user in response to receiving the like from the second user and/or provide the public content from the profile of the first user to the second user prior to the second user liking the public content of the profile of the first user. In many embodiments each of the public and private content may include textual content, video content, and/or audio content.

In a second aspect of the disclosed system, a dating application server system provides a bulk message system in the following manner. The dating application server system receives a list of users to receive bulk messages and a bulk message from a first user. The server system provides the bulk message to each user on the list without an indication that the message is being sent to another user in the list.

In a third aspect of the disclosed system, the dating application provides a discovery mode to allow users in close proximity (e.g., 5 miles, 4 miles, 3 miles, 2 miles, 1 mile or 100 feet) to one another to meet. To provide this feature, the dating application server system performs a discovery mode process in the following manner. The dating application server system receive a request from a user to place the profile of the first user in discovery mode. A group of users within a predefined proximity of the first user is determined and provide selected profile information of the first user to each user in the group. The dating application server system may then receive a request from a second user in the group to view a full profile of the first user (or at least more than just the public profile of the first user) and authorization from the first user to allow the second user to view the full profile or more than just the public profile of the first user. In response to the request and/or authorization, the system allows the second user to access more than just the public profile (preferably full profile) of the first user in response to receiving the authorization and allows the first user to access a full profile or more than just the public profile of the second user in response to receiving the authorization.

In some of these embodiments, the dating application server system establishes a communication link between the first user and the second user in response to receiving the authorization. In some other embodiments, the system may provide select information from the profile of the second user to the first user in response to receiving the like from the second user.

In a fourth aspect of the disclosed system, the dating application may provide recommendations for events and/or venues for a date. To do so in some embodiments, the dating application obtains activity information of a first user and a second user. The system searches the activity information of the first user and the second user for common interests. Common interests include and are not limited to activities, language styles, travel/travelled places, religion and attribute combinations thereof. The common interests are used to select one or more events from a list of stored events that match the common interests. The selected events are then provided to the first and/or second users. The activity information may be gathered from information directly inputted into the system by the user or where the user has allowed the system to gather the information from other sites such as social media accounts of the user.

In a fifth aspect of the disclosed system, the dating application may optionally find potential matches based on a request by the user for a particular personality types as determined based on a personality test. To do so, the dating application server system receives a request for a particular personality type for potential matches from a user, searches profiles of all users for users having the requested personality type; and provides a list of potential matches to the user, the list of potential matches including users that have a personality type that matches the particular personality type. The system may suggest a particular personality type that the user may match with. However, the user may override such suggestion and choose his/her own personality type preference.

In a sixth aspect of the disclosed system, the system may be used to arrange a date between a first and second user. To do so, the dating application server system receives a request for a date between a first user and a second user, provides a list of potential venues for the date, receives a selection of a particular venue for the date, provides a list of purchase options for the venue, receives a selection of purchase options from at least one and preferably both of the first and second users, completes a transaction for the purchase options for each of the at least one of the first and second users by communicating with a third party system of the venue, and provides a message confirming the date to both the first and second users.

In some embodiments, the system may also provide a receipt for the transaction to each of the at least one first and second users that made a purchase.

In a seventh aspect of the disclosed system, the dating application server system generates events for users to attend to meet other users. To promote the event and encourage attendance, the system may conduct a raffle to allow some users to attend the event for free. To do so, the dating application server system generates an event, determines users that may be interested in the event from the profiles of the users, provides an invitation to the event to each of the determined users, receives an acceptance of the invitation from one or more users, and conducts a raffle to provide free attendance to the event for one of the one or more users that sent an acceptance. The other attendees would pay a slightly higher price to pay for the event fee to the raffle winner.

In accordance with some embodiments, the system may also receive payment for the event from at least one of the one or more users that sent an acceptance.

In accordance with an eighth aspect of the disclosed system, a dating application server system may allow users to provide live content to all or a selected group of users. To do so, the dating application server system receives live content from a first user, receives a list of other users to receive the live content, and provide the live content to each user in the list of other users.

### BRIEF DESCRIPTION OF THE DRAWINGS

These and other features and advantages of the various embodiments disclosed herein will be better understood with respect to the following description and drawings, in which like numbers refer to like parts throughout, and in which:

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates devices providing a dating application connected by a network in accordance with an embodiment of the disclosed system.

FIG. 2 illustrates a processing system in a dating application server system in accordance with an embodiment of the disclosed system.

FIG. 3 illustrates a screenshot of a profile from a mobile device providing a dating application in accordance with an embodiment of the disclosed system.

FIG. 4 illustrates a flow diagram of a process performed by a dating application server system to provide public and private profile information to users in accordance with an embodiment of the disclosed system.

FIG. 5 illustrates a screen shot from a mobile device providing a dating application showing a message sharing process in accordance with an embodiment of the disclosed system.

FIG. 6 illustrates a screen shot of a list of users in a user defined group from a mobile device providing a dating application in accordance with an embodiment of the disclosed system.

FIG. 7 illustrates a screen shot of messages of a group on a mobile device providing a dating application in accordance with an embodiment of the disclosed system.

FIG. 8 illustrates a flow diagram of a process performed by a dating application server system to provide group messaging in accordance with an embodiment of the disclosed system.

FIG. 9 illustrates a flow diagram of a process performed by a dating application server to provide a discovery mode in the application in accordance with an embodiment of the disclosed system.

FIG. 10 illustrates a screen shot of an event advertisement on a mobile device providing a dating application in accordance with an embodiment of the disclosed system.

FIG. 11 illustrates a screen shot of a list of upcoming events in an area on a mobile device providing a dating application in accordance with an embodiment of the disclosed system.

FIG. 12 illustrates a flow diagram of a process performed by a dating application server system to provide possible activities for dates in accordance with an embodiment of the disclosed system.

FIG. 13 illustrates a flow diagram of a process performed by a dating application server system to provide potential dating matches between users based on personality types in accordance with an embodiment of the disclosed system.

FIG. 14 illustrates a flow diagram of a process performed by a dating application server system to schedule a date between two users in accordance with an embodiment of the disclosed system.

FIG. 15 illustrates a flow diagram of a process performed by a dating application server system to schedule an event for a group of users in accordance with an embodiment of the disclosed system.

FIG. 16 illustrates a flow diagram of a process performed by a dating application server system to provide live video streams from an event to a group of users in accordance with an embodiment of the disclosed system.

Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of embodiments disclosed herein.

The apparatus and method steps have been represented where appropriate by conventional symbols in the drawings, showing only those specific details that are pertinent to understanding the embodiments disclosed herein so as not to obscure the disclosure with details that will be readily apparent to those of ordinary skill in the art having the benefit of the description herein.

### DETAILED DESCRIPTION

The disclosed system relates to a dating application provided over a network. In accordance with a first aspect of the system, the dating application reduces dating fatigue and reduces the risk of catfishing (i.e., using bots to create fake profiles) by providing mutual private videos matching with media content for real connections. For purposes of this discussion, dating fatigue is exhaustion caused by repetitively answering the same questions and/or performing the same activity over and over again to create small talk when trying to find a match; and catfishing is a user providing false information to attract potential suitors. A second aspect of the disclosed system also reduces dating fatigue by allowing a user to group of suitors and/or friends and send bulk messages and/or provide shared media to the group without the group knowing that they are being sent a bulk or group message. A third aspect of the system provides a discovery mode to allow users to find single people within a short range (e.g., 200 yards or walking distance). A fourth aspect of the disclosed system is the provision of ideas for date activities based on events posted to social media or other received information through an Application Programming Interface (API).

In accordance with some embodiments, a dating application is provided by a data application server system. A user uses a personal device such as a mobile device or home computer to connect to the data application server system to use the dating application. The personal device executes a dating app that communicates with the dating application server system to provide various dating related services in accordance with various aspects disclosed herein.

The disclosed system provides a dating app with private videos or other content (e.g., audio, text, etc.) that is shown to users only after mutual like between users. This video or other content helps save dating fatigue because the user need not repeatedly communicate details about themselves to potential suitors. Rather many other users can view the videos or other content so that the users need not waste time making small talk to get to know each other. The video or other content being private and shared with mutual likes allows the users to limit personal information to be shared and reduces the time spent on communication and reduces dating fatigue by helping the user have more effective and/or meaningful conversations with potential suitors. By providing videos or other content that are private and only shared after mutual likes, the system greatly reduces the burden on the user to talk about these private details that the suitors would naturally share in the next step after the users like each other's profiles and focus more on building a relationship understanding the past details better.

Another aspect of the disclosed system is a private list of suitors to share daily bulk messages/media that appear personal and allows an individual of the group and the original sender to seamlessly carry on a personal electronic communication in a private manner without the individual of the group knowing that this started as a group electronic communication. This private list may be the top certain number of favorite or potential suitors from the many matches made by the application. The bulk message/media may be videos and/or/audio content, text, or any other type of media content shared to show a user's interests including, but not limited to, events for date, outdoor/indoor activities, and basic requests to meet to do an activity. Another aspect of the disclosed system is to share single status (without name mentioned just with basic profile information like age, education, job etc.) of a user to other users in a predefined geographical area such as, but not limited to, a mile radius so as to be discovered/encountered by other potential single users in the area based on GPS location.

The above and other aspects of the disclosed system are described below with reference to the drawings.

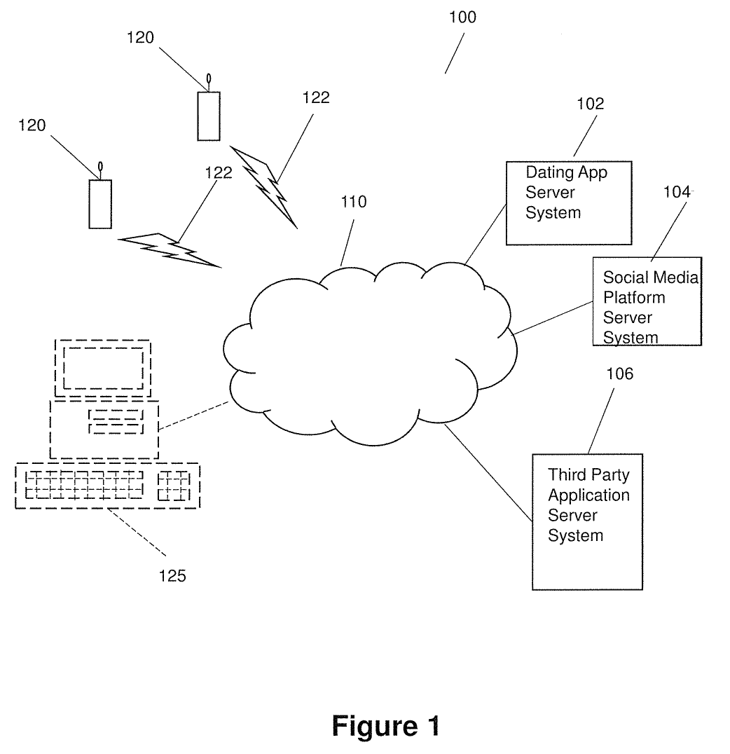

Turning now to the drawings, FIG. 1 illustrates a system 100 for providing an on-line dating application. The system 100 includes a dating application server system 102; social media server system 104; third party application server system 106; and user devices 120 and 125 that are communicatively connected by a network 110.

The dating application server system 102 may be a system that provides the dating application to users via a personal device over the network. To do so, the dating application server system 102 performs processes that provide the various services related to dating and/or matchmaking in accordance with various aspects disclosed herein. Dating application server system 102 may include one or more servers, routers, computer systems, and/or memory systems that are communicatively connected via an internal network to perform the dating application management processes and provide the dating application to users.

The social media server system 104, and the third party application server system 106 are one or more computer systems that each include a memory and a processing unit. Social media platform server system 104 provides a social media platform that provides a repository for media content related to a specific user. Third party application server system 106 performs processes for interacting with a third party for goods or services. For example, a third party application server system 106 may provide a web site that allows a user to purchase tickets for an event or make a reservation at an establishment, or to purchase drinks or meals from an establishment. Each social media platform server system 104, and/or third party application server system 106 may be implemented by a system that includes one or more servers, routers, computer systems, and/or memory systems that are communicatively connected via a network to store and provide data relating to third party venues, goods and/or services.

The network 110 may advantageously be the Internet. Alternatively, the network 110 may be a Wide Area Network (WAN), a Local Area Network (LAN), or any combination of Internet, WAN, and LAN that can be used communicatively to connect the various devices shown in FIG. 1.

The portable personal communication devices 120 are each used by a player to connect to the dating application server system 102 to interact with the dating application to view and communicate with potential suitors to date in accordance with the shown embodiment. Each portable personal communication device 120 may be a smart phone, tablet, Personal Digital Assistant (PDA), a laptop computer, or any other device that is connectable to the network 110 via wireless connection 122. It may also be possible for a player to use a desktop computer 125 to connect to dating application server system 102. The computer 125 may advantageously connect to the network 110 via either a conventional “wired” or a wireless connection. The computer 1.25 may be, for example, a desktop computer, a laptop, a smart television, and/or any other device that connects to the network 110.

Although a particular system of devices is described above with respect to FIG. 1, other system architectures that, add, remove, and/or combine various devices and/or modules may be used to perform various processes in accordance with various other aspects of the disclosure.

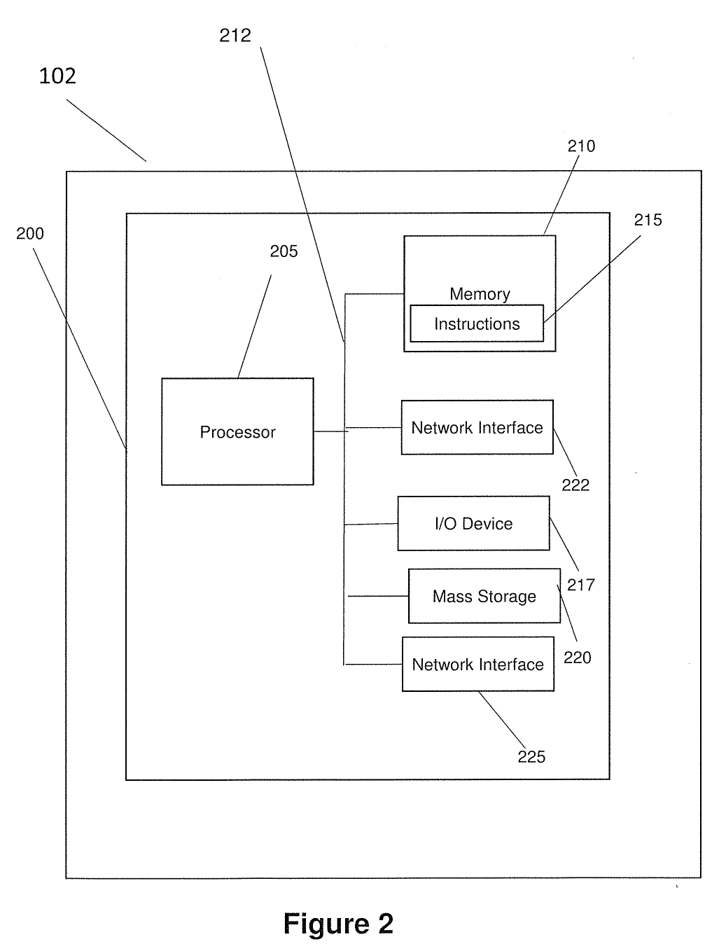

FIG. 2 is a high-level block diagram showing an example of the architecture of a processing system 200 of a computer system in dating application server system 102 according to some embodiments of the disclosure. The processing system 200 can represent a computer system that performs one or more processes that provide an on-line dating application in accordance with an embodiment of the disclosed system. Certain standard and well-known components of a processing system which are not germane to the subject matter of this disclosure are not shown in FIG. 2.

Processing system 200 includes one or more processors 205 in operative communication with memory 210 and coupled to a bus system 212. The bus system 212, as shown in FIG. 2, is a schematic representation of any one or more separate physical buses and/or point-to-point connections, connected by appropriate bridges, adapters and/or controllers. The bus system 212, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The one or more processors 205 are the central processing units (CPUs) of the processing system 200 and, thus, control its overall operation. In certain embodiments, the one or more processors 205 accomplish this by executing software stored in memory 210. The processor(s) 205 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 210 represents any form of random access memory (RAM), read-only memory (ROM), flash memory, or the like, or a combination of such devices. Memory 210 includes the main memory of the processing system 200. Instructions 215 implementing the process steps of processes described below may reside in memory 210 and are executed by the processor(s) 205 from memory 210.

Also advantageously connected operatively to the processor(s) 205 through the bus system 212 are one or more internal or external mass storage devices 220, and a network interface 222. The mass storage device(s) 220 may be, or may include, any conventional medium for storing large volumes of data in a non-volatile manner, such as one or more solid state, magnetic, or optical based disks. The network interface 222 provides the processing system 200 with the ability to communicate with remote devices (e.g., storage servers) over a network, and may be, for example, an Ethernet adapter, a Fiber Channel adapter, or the like.

The processing system 200 also advantageously includes one or more input/output (I/O) devices 217 operatively coupled to the bus system 212. The I/O devices 217 may include, for example, a display device, a keyboard, a mouse, etc.

Although an example of an architecture of a processing system is described above with respect FIG. 2, other architectures of processing systems that add, combine, and/or remove are possible in accordance with various other embodiments of this disclosure.

In accordance with some aspects of the disclosed system, the dating application reduces dating fatigue by providing features that reduce the amount of messaging that a user has to do to select one of the potential suitors. One such feature is permitting users to view private content in another user's profile based mutual consent of each other's public content. The private information may be more personal information that a user normally shares before a date to meet is set. The more personal information may include but is not limited to a privately held spiritual belief, a secret activity that the user participates in but the user's family might not know about deal breakers, or must want aspects in the potential match. The use of public and private information reduces the time spent on communication and reduces dating fatigue by promoting more effective meaningful conversations. Dating fatigue is caused by repeatedly texting/talking with many suitors about basic but private personal details the one does not normally make public including but not limited to details of past education, places lived/travelled, religious/spiritual beliefs, personality type, hobbies/passions, and life journey details. By having videos in private information to share this information, the burden on the user to talk about these details is reduced and the user has more control over what is shared to the general public. The user can focus more on building a relationship by understanding the past details better.

A process that allows the sharing of private information based on mutual consent may be performed in the following manner. A first user may be view public profiles of other users. The first user then finds a second user interesting based on the second user's public profile. The first user inputs a ‘like’ or other positive signal of the second user's public profile. A notification is then sent to second user. The notification may include information from the first user's public profile or a link to the first user's public profile. The second user then inputs an ‘accept’ of the first user. The system then allows the first user and second user to view the private profiles or private profile information of each other and communications between the two users may be established.

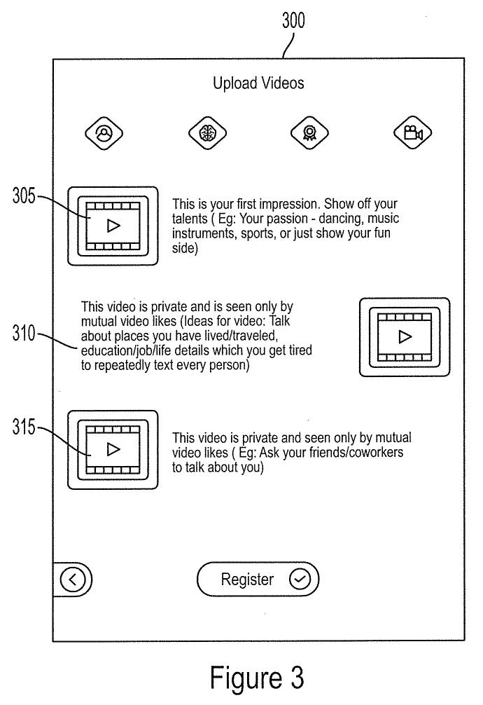

FIG. 3 illustrates a screen shot of a profile of a user of the dating the application. Profile 300 includes public content 305 and private content 310, 315. The public information may be text, video and/or audio content that generally conveys the interests, likes, dislikes and other relevant information about the user. The private content 310, 315 may be text, video, and/or audio content that provides more detailed and/or candid information about the user. The private content is normally information that one shares before setting or agreeing to a date but is too personal to make available in a public setting where everyone can view the information. As indicated above, the public religious belief of a person might be associated with one's family but the privately held belief of the person may be included in the private content that is shared only after mutual likes of two users are established.

The private content may be saved as a virtual folded letter format in that the user can choose to save their private information in letter forms and choose to reveal a portion or all or specific letter to the other match(es) as intended to save dating fatigue. It could also be helpful in sharing specific skills related info like maybe poetry or other sections like adventure/travel/art/music related categories based virtual letters which can be used to share with a particular second user matched with the first user when required. This could be used after both users are matched by mutual like and shared or when they chat with each other.

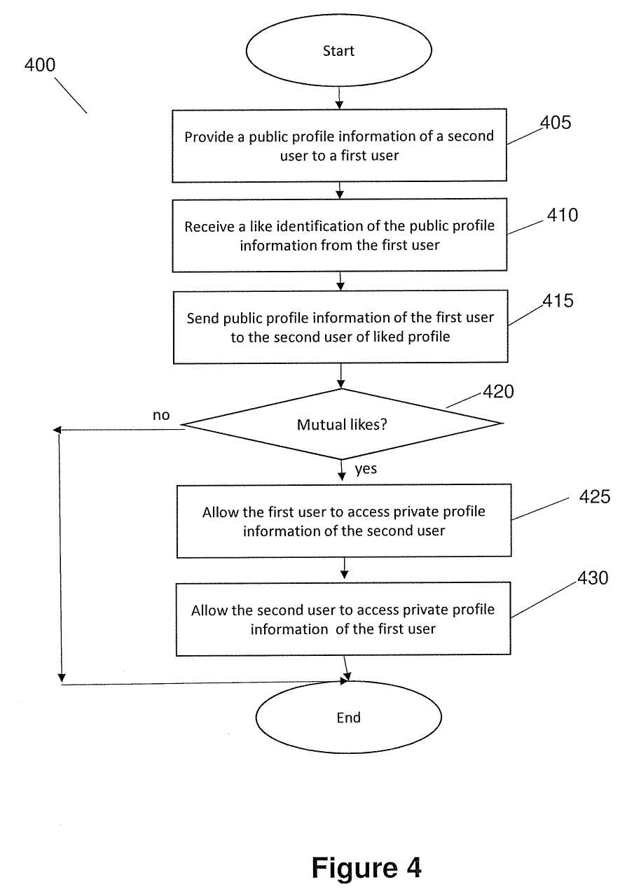

A process performed by the dating application server system to provide public and private content is shown in FIG. 4. The process 400 may be begin by providing public profile information of a second user to a first user (405). In accordance with some embodiments, the public profile content may be selected information from the profile of the second user. In accordance with some other embodiments, the public profile content may be a separate profile or portion of a profile of the second user. The public profile content may be textual, video and/or audio content in the various different embodiments.

A like of the public profile content of the second user is received from the first user (410). In response to the like of the first user liking the public profile content of the second user, a notification of the like is sent to the second user. The notification may be a message provided to the second user's account in the data application system in some embodiments. In some other embodiments, the notification may be an e-mail, SMS message, or some other type of message sent to an account associated with the second user. The notification includes public profile content of the first user. In some embodiments, the public profile content may be selected information the profile of the first user. In some other embodiments, the public profile information may be a link to a public profile or a public portion of a profile of the first user.

The second user may then input a ‘like’ or an acceptance to the ‘like’ of the first user. If the system receives a ‘like’ or acceptance of the first user, the system determines that there is a mutual like (420). If there is a mutual like, the system allows the first user to access the private profile content of the second user (425) and the first user to access the private content of the second user (430). In accordance with some embodiments, the private profile content may be select information from the profile of a user. In accordance with some other embodiments, the private profile content may be a separate profile or portion of a profile of a user. The public private content may be textual, video and/or audio content in the various different embodiments. After mutual access is granted or if a mutual like is not received, the process 400 ends.

A process for providing mutual access to private profile content is described above with respect to FIG. 4, other processes for providing mutual access that add, remove, and/or combine steps are possible in accordance with various other embodiments of the system.

According to another aspect of the disclosed system, another feature of the system that reduces dating fatigue is providing a bulk message to a group of recipients that are led to believe the message is personal. As such, each user that receives the bulk message is provided the message without any indication that the message was also sent to other users. Further, when one of the recipients replies to the message, the reply can only be seen by the sender. This allows the sender to send the same message to several potential suitors that are under the impression that the message is part of a private conversation with the user.

In addition, some aspects of the disclosure provide a similar feature in which a send may send a message to a group of users that appear personal and allows an individual of the group and the original sender to seamlessly carry on a personal electronic communication in a private manner without the individual of the group knowing that this started as a group electronic communication. alternatively this feature may allow the user to communicate with a group of friends for dating advice and/or other communications. The recipient may send a response to the message without the responsive message being forwarded to others in the group. This allows the original user that sent the message to the group to get dating advice from a friend and the friend does not know that the message started as a group message.

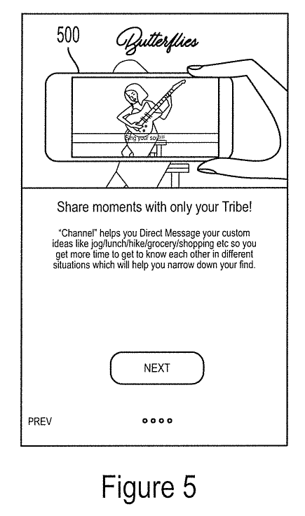

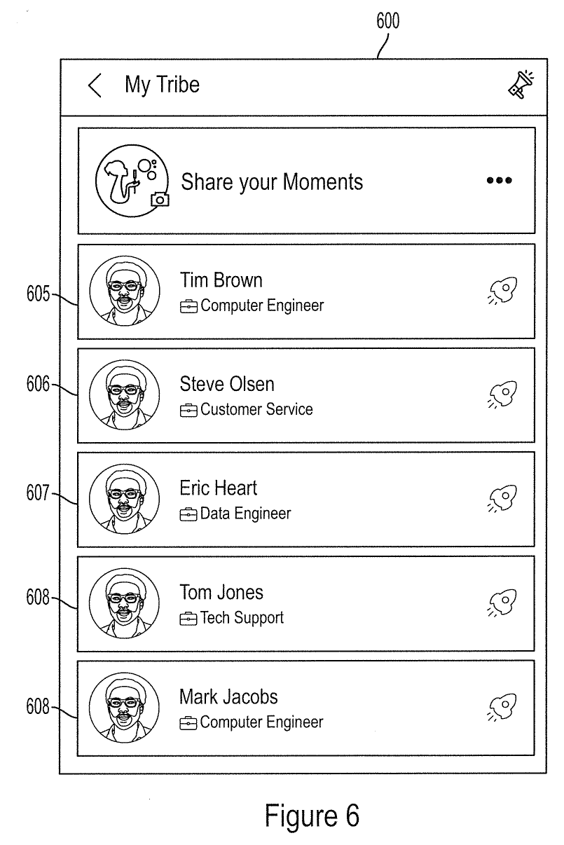

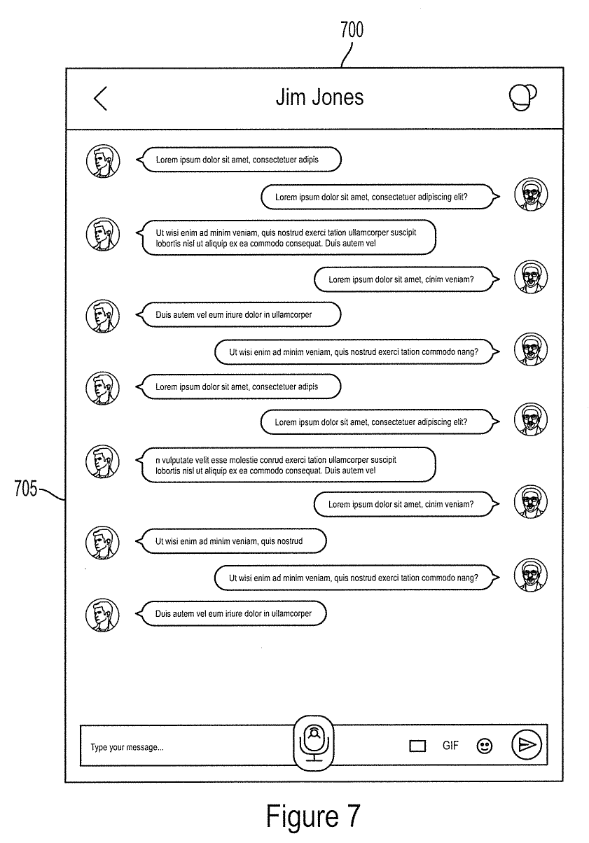

To provide this feature, the user generates content such as the content shown in the screen shot 500 shown in FIG. 5. The user may generate a list of user termed a tribe to receive particular messages. FIG. 6 shows a screenshot 600 of a list of users 605-608 in a group or tribe to receive messages. FIG. 7 shows a screenshot 700 of messages 705 received from a user in response to a mass message where the response are only provided to the user that sent the message.

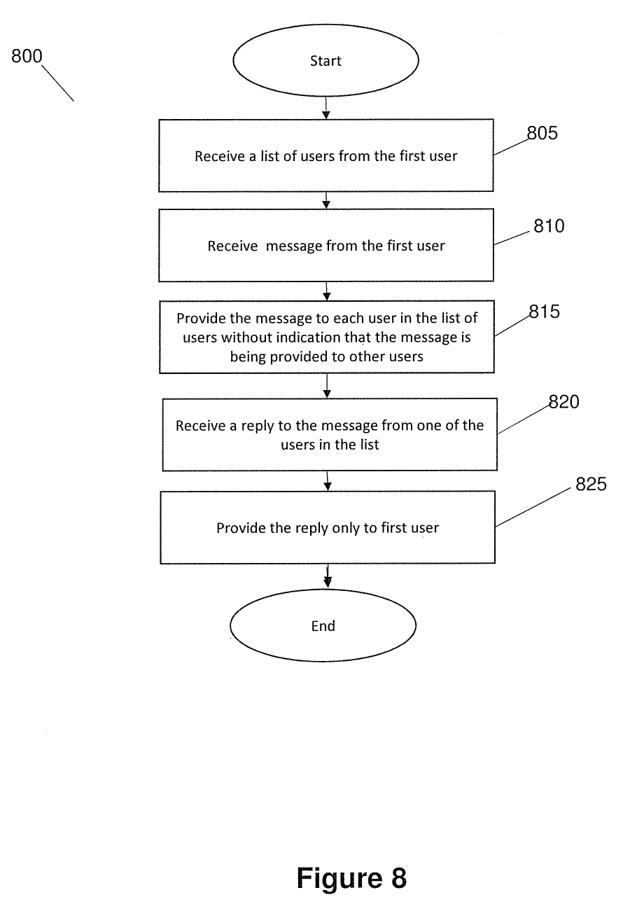

A process performed by the dating application server system for providing bulk messages that appear as private messages to a recipient in accordance with an aspect of the disclosure is shown in FIG. 8. A process 800 begins by receiving a list of user recipients associated with a first user (805). In some embodiments, the groups may be user created. In some other embodiments, the groups may be selected by the dating application server system in accordance to a matchmaking algorithm or some user matching algorithm. The list may include potential suitors for the user in some embodiments and in some other embodiments, may include friends or other contacts of the user. As used herein, the dating application server system may include a data application service provider that controls a dating application server system.

The message is then generated from content provided by the first user (810). The message may include textual, video and/or audio content in the various embodiments. The generated message is provided to each recipient user in the list of user without an indication that the message is also being provided to other users (815). The message may be provided as an e-mail, a SMS message, a direct message in the dating application system and/or a posting to a user's profile page in various embodiments. To make the message seem personal to the user, the message may not include a list of other recipient either in a recipient or ‘to:’ field or in ‘also copied’ or ‘CC’ field of the e-mail or other type of message.

The process 800 receives a response to the message from a second user on the list (820). The process 800 provides the response to only the first user that sent the message (825) and the process 800 ends. The response may be an e-mail, SMS message, posting to the profile of the user or some other type of message that is only shared with the first user that sent the first message. In some embodiments, the dating service platform may restrict the second user from adding additional users to the response and/or disables a ‘reply all’ function to send the message.

A process for providing bulk messages that appear as private messages to a recipient in accordance with an aspect of the disclosure is described above with respect to FIG. 8, other processes that provide bulk messages that appear as private messages to a recipient that add, remove and/or combine steps of the process are possible in accordance with various other embodiments of the disclosed system

In accordance with another aspect of the disclosed dating application system, another feature to reduce dating fatigue is a discovery mode. In a discovery mode, a first user makes selected information from their profile available to other users within a predefined area near the user. A second user may see the selected information and ‘like the profile of the first user. In response to the like, the system provides selected information from the profile of the second user to the first user. The first user may ‘like’ or ‘accept’ the second user. When both user have like or accepted each other, the system may make the full profile of each user available to the other and/or establishes communication via message or some other mode between the users. The vicinity of the user's location may be shown in a virtual map which may or may not correspond to a real geographical location but could be an approximation. The user may be given the option to hide the user's location for privacy reasons. The user may activate the hide option by depressing a hide selection on a display. If a map is used, then the user profile picture can be used as a marker on the map. Tapping on the user profile picture can display a profile video of the user (e.g., a trailer) and pop a card with the user's public information. The number of users to connect using this discovery mode could be made limited to a certain number. If the user would like to increase or be added then the user could pay for such service using a credit card or virtual currency. This is more of an instantaneous live dating scenario making it easy to connect and save time. The public profile shown about the person in the vicinity could also include the Myer Briggs type indicator which is MBTI personality type.

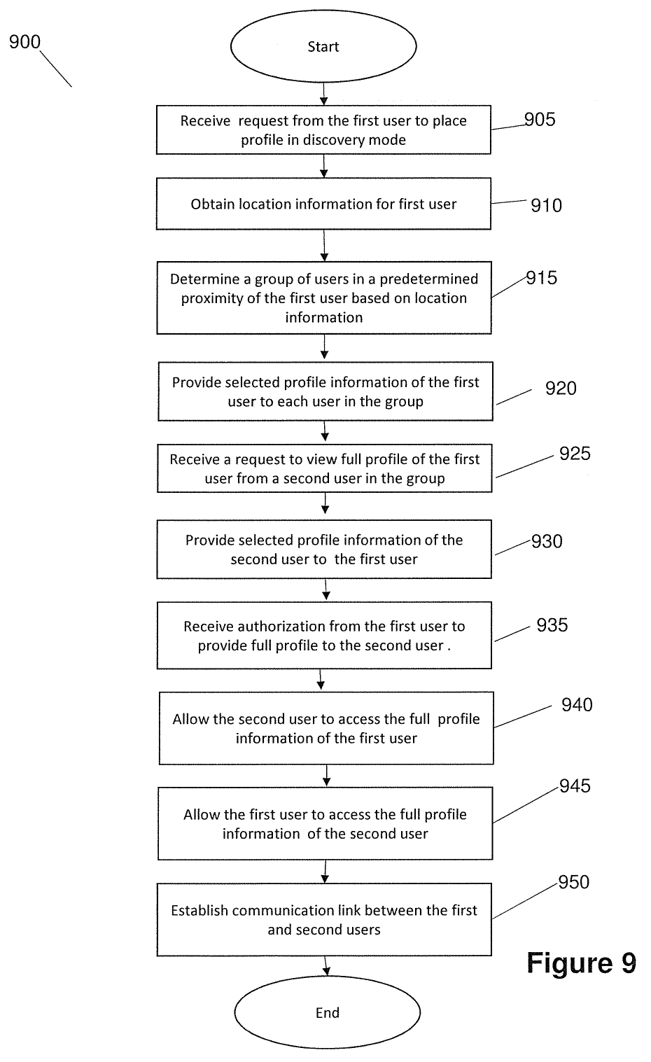

A process performed by the dating application server system to provide a discovery mode to allow users in close proximity to meet in accordance with an aspect of the disclosure is shown in FIG. 9. A process 900 may begin by receiving a request from a first user to place the profile of the first user in discovery mode (905). The system obtains location information for the first user (910). In some embodiments, the location information may be obtained from a Global Position System (GPS) related to a user device that the first user is using to communicate with the dating application server system. In some other embodiments, the location information may be received as an input from the first user. In still other embodiments, the location may be received by a selection of a venue from a list of venues provided by the system.

The process determines a group of users that are within a predetermined proximity to the first user (915). The predefined proximity may be 5 miles, 4 miles, 3 miles, 2 miles, 1 mile or 100 feet in various embodiments of the system. In some embodiments, the predetermined proximity may be within a predefined area proximate the user. For example, all users within one square mile of the user may be determined. In some other embodiments, the predetermined proximity may be the same venue or event.

The process provides selected profile information of the first user to each user in the determined group (920). The selected information is only basic information that may give a viewer insight into the attributes or traits of the user. For example, the selected information may include age, height, weight, occupation, and/or favorite activities.

The process receives a request to view the full profile (or at least more than just the public profile of the first user) of the first user from a second user in the group (925). The process provides the request including selected profile information of the second user to the first user (930) and receives an approval or acceptance of the second user from the first user (935). The process then allows the second user access to at least more than the public profile or more preferably the full profile information of the first user (940) and the first user full access to the at least more than the public profile (or the full profile) information of the second user (945). The process may then establish a communications link such as a messaging session between the first and second users to allow the first and second users to communicate (950) and the process 900 ends. Once communication is established, the profile of the first user is taken off discovery mode since the two users would meet immediately.

The above is a description of a process for providing a discovery mode in accordance with an embodiment of the disclosure with reference to FIG. 9. However, other processes for providing a discovery mode that add, remove, and/or combine steps are possible in accordance with various other embodiments.

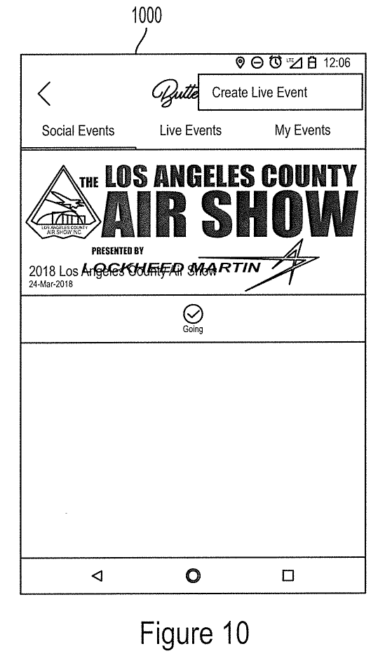

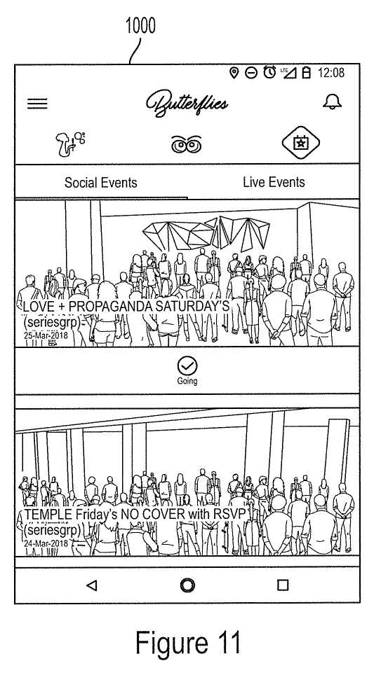

In another aspect, the dating application server system may maintain a listing of events. For each event, the system may store time and location for the event. The dating application server system uses the list of events to plan group events for users to meet and to make suggestions for dates between two or more users. Screen shots 1000 and 1100 from a mobile device of a user showing a list of events are shown in FIGS. 10 and 11.

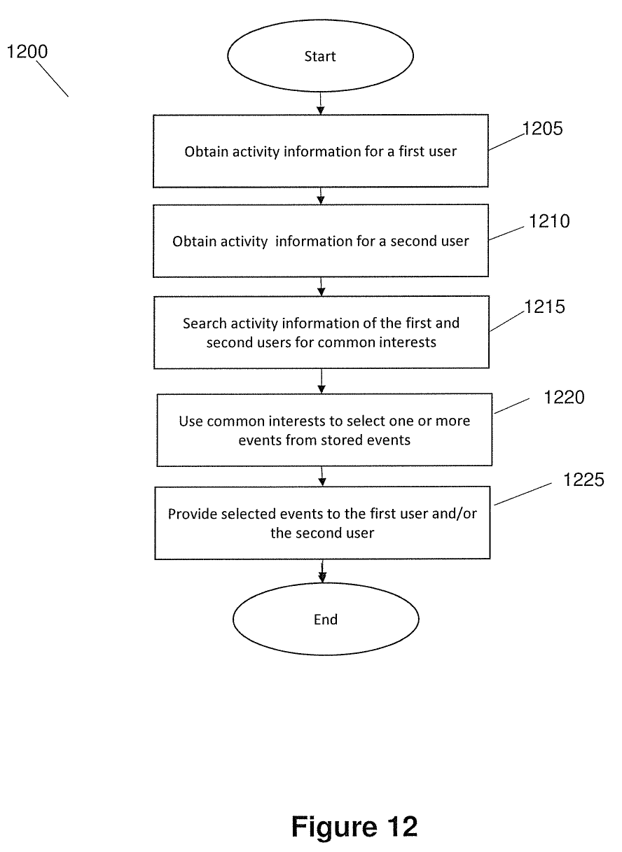

A process performed for recommending events for possible dates based on a stored list of events is shown in FIG. 12. A process 1200 obtains activity information from a first user (1205) and a second user (1210) when the first and second users “like” each other's profiles. The activity information may be received as input information from a user, by searching social media information from a social media account of a user, or by searching e-mails or other stored information of a user. The search of other stored information may be from meta data or descriptions used in pictures associated with the user or even recognition of pictures or places based on geographical markers in the photo itself. If the search is of the user's social media, smartphone text or user's email, then the system may request access to those accounts and the user must give the system permission to search those accounts for common interests and store them in a database in the system associated with the user. Alternatively, the system need not store the information of the users from the accounts of the user outside of the system in the memory of the system. Rather, the system would search the outside accounts of the users only when activities are suggested by the system to the users on the dating application or communicated to the users via other electronic communication such as email and/or text. The activity information of the first and second users is searched for common interests (1215). Common interests include and are not limited to activities, language styles, religion and combinations thereof. The common interests are then used to search a stored list of events to determine a list of likely date settings that includes each event that matches one or more common interests of the first and second users (1220). The list of likely date setting is then provided to the first and/or second users (1225) and the process 1200 ends. The list of likely date setting may be communicated to one or both of the users through the dating application, email and/or text. The communication may include a visual graphic of the activity and other information relevant to the users to decide whether the activity is acceptable. The list of likely date setting may be an actual event that is only suggested if the calendars of both users show that they have no events on the date and time of the actual event. For example, the system may identify a list of likely date setting (e.g., events held at a particular place, time and date) and the system may access the online calendars of the users and only suggest the likely date settings (e.g., events) where both users are available. The users would have allows the system access to their calendars.

An embodiment of a process for providing likely date settings in accordance with an aspect disclosed herein is described above with reference to FIG. 12. However, other processes for providing likely date setting that add, remove, and/or combine the described steps are possible in accordance with various other embodiments.

Another aspect of the disclosed is system is that the dating application server system provides possible matches of users based on personalities as determined by personality test. One example of a personality test is the Myers-Briggs personality test that is commonly available. The system may provide the test or the user may input their personality as classified by the test. A user may then enter his or her personality type and also the personality type as defined by the personality test that the user wants to meet. The system may suggest other users that are believed to be compatible with the user but in this regard, the system may allow the user to select the type of personality that he/she would like to meet. The system may then find other users that match the user's requested or inputted personality.

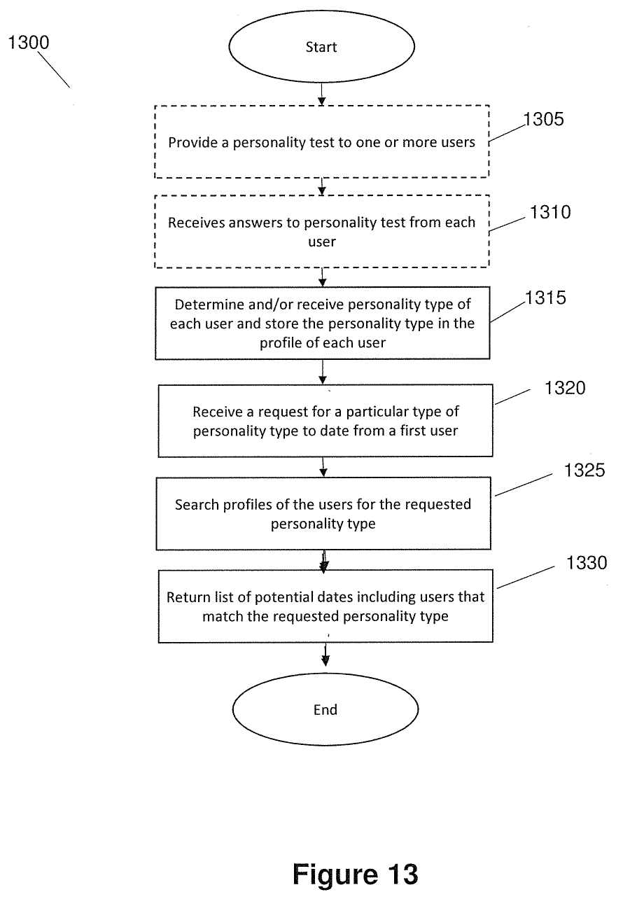

A process performed by a dating application server system to provide dating matches based on personality types determined from a personality test in accordance with an embodiment of the disclosed system is shown in FIG. 13. A process 1300 optionally begins by providing a personality to test to each user (1305). An example of a personality test that may be given is the Myers-Briggs test. However, other personality tests may be used in other embodiments. The process may then receive inputs of answers to the test (1310). The process either receives an input of the personality type from the users or determines the personality type of each user from the received answers (1315). By way of example and not limitation, the Myers Briggs test categorizes people into 16 different types of personalities, namely, ISTJ, ISTP, ESTP, ESTJ, ISFJ, ISFP, ESFP, ESFJ, INTJ, INTP, ENTP, ENTJ, ENFP, INFP, ENFJ and INFJ. The personality type is then stored with the users profile information by the system.

A request for matches of a particular personality type is received from a first user (1320). The system may suggest a particular personality type that the user may want to match. For example, the system may suggest a user with a personality type of ESTP or ISFP to another user whose personality type is ESFP, and vice versa. However, the system may allow the user to override such suggestion and choose his/her own personality type preference. The user may request users having personality types outside of known statistically good matches of personality types. For example, the user with the personality type of ESTP may request other users having other personality types other than ESTP and ISFP. The profiles of the users are then searched for the user requested personality type (1325) (not of the system generated personality type) and a list of potential matches or dates that match the requested personality type are returned to the first user (1330). The process 1300 then ends. The first user and the matched user can like each other's profiles to begin the online courting and communicate with each other.

An embodiment of a process for providing potential matches based on personality types determined from a personality test in accordance with an aspect disclosed herein is described above with reference to FIG. 13. However, other processes for providing potential matches based on personality types determined from a personality test that add, remove, and/or combine the described steps are possible in accordance with various other embodiments.

Yet another aspect of the disclosed system is that the system may provide a process for arranging a date at a particular venue and pre-buying goods or services for the date to assure that both parties attend the date. This feature reduces the chances of one of the parties not showing up for the date and ‘standing up’ the other party.

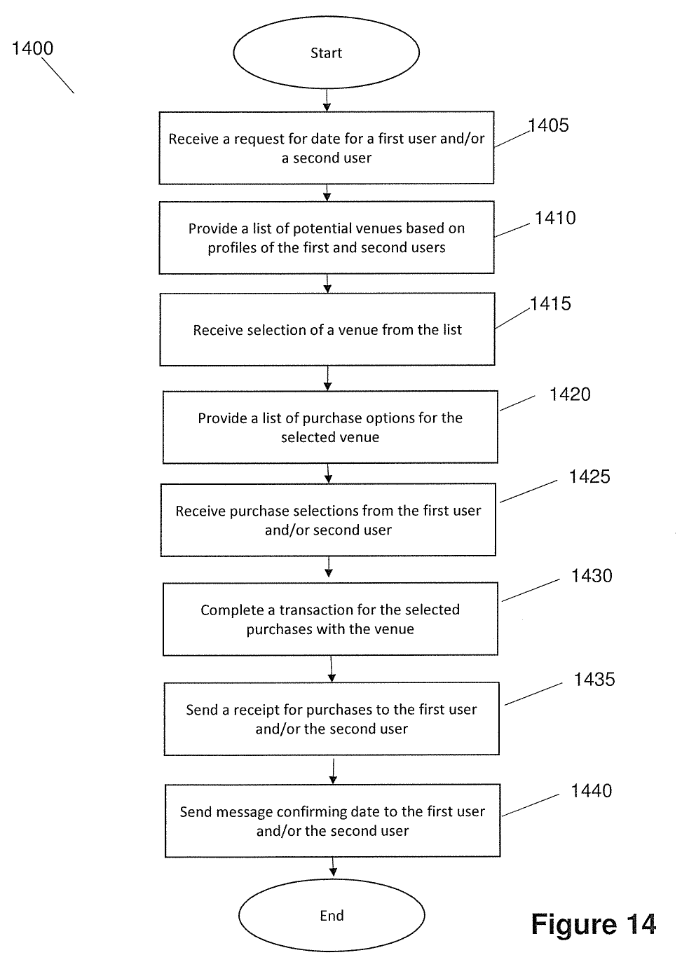

A process performed by the dating application system for arranging a date is shown in FIG. 14. A process 1400 receives a request for a date for a first and second user from one or both of the first and second users (1405). A list of potential venues is provided to the first and/or second user based upon the profiles of the first and second users (1410). A selection of one of the venues is received from at least one of the first and second users (1415). A list of purchase options for the selected venue is provided to the first and/or second users (1420). For purposes of this discussion, purchase options may include, but are not limited to, food, beverages, and event tickets.

A selection of options to purchase are received from the first and/or second users (1425). The dating application server system communicates with a third party system of the venue to complete transactions for the selected purchase items (1430). Receipts for the purchased options are then provided to the first and second users (1435). A message of a confirmed date is provided to the first and/or second users in response to the completed transaction by either one of the users but preferably both of the users. The message may be provided via e-mail, SMS message, or a direct message within the system to both users. The process 1400 then ends.

An embodiment of a process for arranging a date in accordance with an aspect disclosed herein is described above with reference to FIG. 14. However, other processes for arranging a date that add, remove, and/or combine the described steps are possible in accordance with various other embodiments.

In still another aspect, a dating application system arranges events for users to meet potential matches. To induce attendance and to generate revenue, the system may place a surcharge for the event and conduct a raffle to allow one or more users to attend the event free of charge.

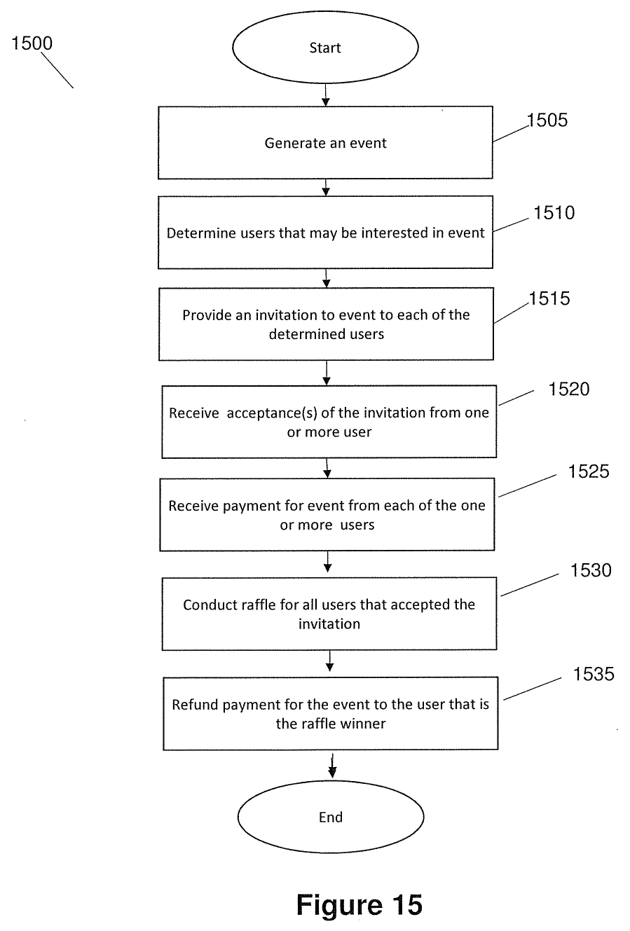

An embodiment of a process performed by the dating application server system to arrange events is shown in FIG. 15. A process 1500 generates an event. The event may be selected from a list of events maintained by the system (1505). User profiles are used to determine users that may be interested in attending the event (1510). Invitations to the event are then provided to each of the determined users (1515). The invitations may be provided via a posting to a user's account, an e-mail, a SMS message, or any other manner in which the invitation may be provided to each user.

Acceptances of the invitation are received from one or more user (1520) and payment for the event is received with or in response to the acceptance of the invitation (1525). A raffle may be conducted that includes all of the users that accepted the invitation (1530) and the payment for the event of the raffle winner is refunded (1535). More particularly, the system may randomly select one of the users that accepted the invitation. The system may refund the payment from the selected one of the users. He or she is the winner of the raffle. Process 1500 then ends.

An embodiment of a process for arranging an event in accordance with an aspect disclosed herein is described above with reference to FIG. 15. However, other processes for arranging an event that add, remove, and/or combine the described steps are possible in accordance with various other embodiments.

In yet another aspect of the disclosed system, a dating application server system allows a user to post live media content to a selected group of users. The live media content may be text, video, and/or audio content. The users may be a group of friends, a group of suitors, or a group including a combination of friends and suitors.

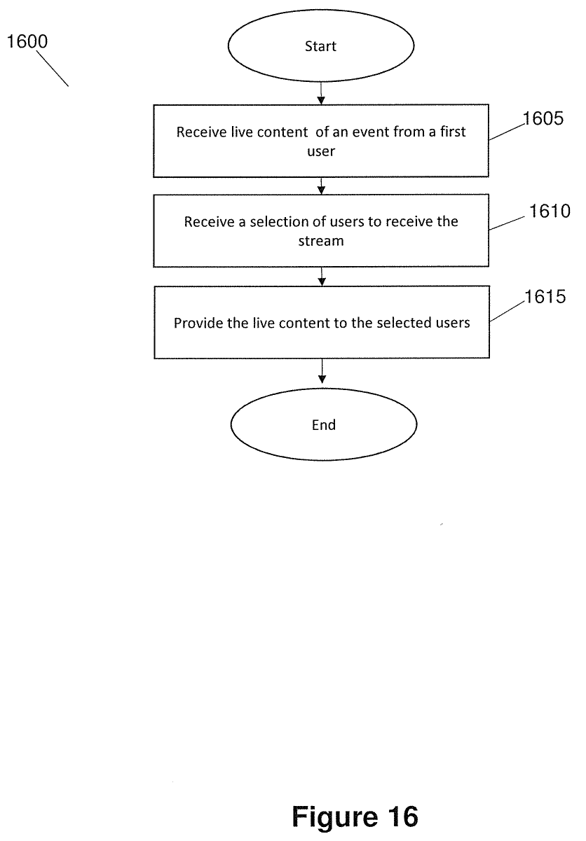

A process performed by the dating application server system to provide live content to a selected group of users in accordance with an aspect of the disclosure is shown in FIG. 16. A process 1600 receives live content of an event from a first user (1605). The user provides a selection of users to receive the live content. The selection of users may be a group of friends, a group of potential matches, or a combination of these groups. The live content is provided to the selected users (1615) and process 1600 ends.

An embodiment of a process for providing live content to selected user in accordance with an aspect disclosed herein is described above with reference to FIG. 16. However, other processes that provide live content to selected users that add, remove, and/or combine the described steps are possible in accordance with various other embodiments.

What is claimed is:

1. A system for providing an on-line dating application, comprising:
at least one processor; and
memory readable by the least one processor and storing instructions that, when read by the at least one processor, direct the at least one processor to:
receive a like of public content from a profile of a first user from a second user,
receive an acceptance of the like from the first user,
provide access to private content in the profile of the first user to the second user in response to receiving the acceptance from the first user, and
provide access to private content in a profile of the second user to the first user in response to receiving the acceptance from the first user.

2. The system of claim 1 wherein the instruction further direct at least one processor to:
provide private content from the profile of the second user to the first user in response to receiving the like from the second user.

3. The system of claim 1 wherein the instructions further direct the at least one processor to:
provide the public content from the profile of the first user to the second user prior to the second user liking the public content of the profile of the first user.

4. The system of claim 1 wherein public content is content selected from a group consisting of textual content, video content, and audio content.

5. The system of claim 1 wherein private content is content selected from a group consisting of textual content, video content, and audio content.

6. The system of claim 1 wherein the instructions further direct the at least one processor to:
receive a list of users to receive bulk messages from a first user,
receive a bulk message from the first user,
provide the bulk message to each user on the list without an indication that the message is being sent to other user in the list.

7. The system of claim 1 wherein the instructions further direct the at least one processor to:
receive a request from a user to place the profile of the first user in discovery mode,
determine a group of users within a predefined proximity of the first user,
provide selected profile information of the first user to each user in the determined group of users,
receive a request from a second user in the group of users to view a full profile of the first user,
receive authorization from the first user to allow the second user to view the full profile of the first user,
allow the second user to access the full profile of the first user in response to receiving the authorization, and
allow the first user to access a full profile of the second user in response to receiving the authorization.

8. The system of claim 7 wherein the instructions further direct the at least one processor to:
establish a communication link between the first user and the second user in response to receiving the authorization.

9. The system of claim 7 wherein the instructions further direct the at least one processor to:
provide select information from the profile of the second user to the first user in response to receiving the like from the second user.

10. The system of claim 1 wherein the instructions further direct the at least one processor to:
obtain activity information of a first user,
obtain activity information of a second user,
search the activity information of the first user and the second user for common interests,
select one or more events from a list of stored events based upon the common interests of the first user and the second user, and
provide the selected one or more events to at least one of the first user and the second user.

11. The system of claim 1 wherein the profile of each user includes a personality type based on a personality test and the instructions further direct the at least one processor to:
receive a request for a particular personality type for potential matches from a user;
search profiles of all users for users having the requested personality type; and
provide a list of potential matches to the user, the list of potential matches including users that have a personality type that matches the particular personality type.

12. The system of claim 1 wherein the instructions further direct the at least one processor to:
receive a rest for a date between a first user and a second user;
provide a list of potential venues for the date;
receive a selection of a particular venue for the date;
provide a list of purchase options for the venue,
receive a selection of purchase options from at least one of the first and second users;
complete a transaction for the purchase options for each of the at least one of the first and second users by communicating with a third party system of the venue, and
provide a message confirming the date.

13. The system of claim 12 wherein the instructions further direct the at least one processor to:
provide a receipt for the transaction to each of the at least one first and second users that made a purchase.

14. The system of claim 1 wherein the instructions further direct the at least one processor to:
generate an event;
determine users that may be interested in the event from the profiles of the users;
provide an invitation to the event to each of the determined users;
receive an acceptance of the invitation from one or more users; and
conduct a raffle to provide free attendance to the event for one of the one or more users that sent an acceptance.

15. The system of claim 14 wherein the instructions further direct the at least one processor to:
receive payment for the event from at least one of the one or more users that sent an acceptance.

16. The system of claim 1 wherein the instructions further direct the at least one processor to:
receive live content from a first user;
receive a list of other users to receive the live content; and
provide the live content to each user in the list of other users.

17. A method for providing an on-line dating application comprising:
receiving a like of public content from a profile of a first user in a data application server system from a second user using a second user device,
receiving an acceptance of the like by the first user from a first user device in the dating application server system,
providing, using the dating application server system, access to private content in the profile of the first user to the second user in response to receiving the acceptance from the first user, and
providing, using the dating application server system, access to private content in a profile of the second user to the first user in response to receiving the acceptance from the first user.

18. A system for providing a dating application comprising:
a user mobile device comprising:
a processor, and
memory readable by the process that when read by the processor directs the processor to:
provide a dating application that communicates with a dating application server; and
a dating application server system comprising:
at least one processor; and
memory readable by the least one processor and storing instructions that, when read by the at least one processor, direct the at least one processor to:
receive a like of public content from a profile of a first user from a second user,
receive an acceptance of the like from the first user,
provide access to private content in the profile of the first user to the second user in response to receiving the acceptance from the first user, and
provide access to private content in a profile of the second user to the first user in response to receiving the acceptance from the first user.
